(19) United States
(12) Patent Application Publication
(10) Pub. No.: US 2004/0205131 A1
(43) Pub. Date: Oct. 14, 2004

(54) Multimedia information communication service system, user terminal program, and recording medium

(76) Inventors: Nozomu Saruhashi, Osaka-shi (JP); Masahide Uemura, Osaka-shi (JP); Katsunori Shimamoto, Osaka-shi (JP); Yu Yasumi, Osaka-shi (JP)

Correspondence Address: Joseph R Keating, Keating & Bennett, Suite 312, 10400 Eaton Place, Fairfax, VA, 22030, US

(21) Appl. No.: 10/481,631

(22) PCT Filed: Jun. 24, 2002
(86) PCT No.: PCT/JP02/06301

(30) Foreign Application Priority Data
Jun. 25, 2001 (JP) 2001-192061

(51) Int. Cl. G06F 15/16

(52) U.S. Cl. 709/205; 709/231

(57) ABSTRACT

A sophisticated information communication service system in which multimedia contents such as moving images, still images, and text are registered in advance and are fetched when required with holding bidirectional conversation functions using multimedia information including TV pictures and sounds for providing conferences, education, medical care, nursing care, various consultations, and the like. The information communication service system comprises: a bidirectional communication server (10) for conducting bidirectional multimedia communication; a contents management server (12) for storing multimedia contents; and a contents delivery server (14) for delivering the contents stored in the contents management server to user terminals. The contents management server has a contents archiver (16) storing material contents, and performs delivery based on a scenario which defines a combination of material contents along the time axis. The bidirectional communication server also has a data conference function and a chat function. A resource management function and an accounting function are also provided.

### BACKGROUND OF THE INVENTION

1. Field of the Invention

This invention relates to a multimedia information communication service system for providing interactive information communication services such as conferences, education, medical care, nursing care, and various consultations through the use of multimedia information including images and sounds.

2. Description of the Related Art

Among conventional information communication service systems is a video conference system as shown in FIG. 23. In the diagram: the reference numerals 1a, 1b, . . . , 1n represent video conference terminals, reference numerals 2a, 2b, . . . , 2n, and 5a, 5b, . . . , 5n represent communication lines, 3 a multipoint control unit for multipoint communications, which connects the plurality of video conference terminals over the communication lines, and 4 a reception terminal for conference reception. Each of the video conference terminals includes a display for displaying images, a TV camera for capturing images, a headphone set including a microphone for capturing voice and earphones for hearing, and a personal computer having a built-in TA (terminal adaptor). The video conference terminals are connected with the multipoint control unit 3 and the reception terminal 4 over the communication lines. ISDN-based telephone lines and/or dedicated lines are used for the communication lines.

For information communication services using this video conference system, users first call the center where the reception terminal is, and place their orders for the services. If the reception terminal confirms that the callers are predetermined users, it connects the video conference terminals of the users with the multipoint control unit. This enables the individual users to conduct bidirectional communications using images and sounds, making conference, education, and other services available to even those at geographically remote locations.

For situations with three or more users, the multipoint control unit synthesizes the images of the connected video conference terminals for split display. Consequently, a plurality of users are provided with identical services at the same time.

Nevertheless, such conventional video conference systems are primarily intended for face-to-face conversations between remote locations, and are not adequate for sophisticated applications such as conferences, education, medical care, nursing care, and various consultations that are performed through the full use of a variety of multimedia content stored in advance, including moving images, still images, and text.

### SUMMARY OF THE INVENTION

To overcome the problems described above, preferred embodiments of the present invention provide sophisticated information communication services in which multimedia content such as moving images, still images, and text are registered in advance and are retrieved when required while holding bidirectional conversation using multimedia information including TV pictures and sounds for performing conferences, education, medical care, nursing care, various consultations, and other suitable services.

A multimedia information communication service system according to a preferred embodiment of the present invention includes a bidirectional communication device for providing, between user terminals, a bidirectional communication function using multimedia information including TV pictures and sounds, a content management device for storing multimedia content to be delivered to the user terminals; and a content delivery device for delivering the content stored in the content management device to the user terminals.

In the multimedia information communication service system according to the present invention, the content management device includes a material content storing device for storing materials of the content to be delivered, or material content, and a scenario storing device for storing a scenario defining a combination of the material content along time axis. Here, the content delivery device fetches and delivers the material content stored in the material content storing device based on the scenario stored in the scenario storing device.

This facilitates providing a sophisticated presentation using a plurality of content in combination.

In the multimedia information communication service system according to the present invention, the bidirectional communication device preferably synthesizes the multimedia information transmitted from the plurality of user terminals and delivering the resultant to the user terminals.

This eliminates the need for the user terminals to receive and display the multimedia information of the individual user terminals separately, thus, reducing the load on the user terminals.

In the multimedia information communication service system according to the present invention, the bidirectional communication device preferably delivers the multimedia information transmitted from the plurality of user terminals to user terminals other than the sources thereof separately.

This prevents the user terminals from receiving their own images delivered back to them, thereby reducing the load on the network. Since the user terminals receive and display the multimedia information of the individual user terminals separately, they improve in the flexibility of screen display and sound output on the user terminals.

In the multimedia information communication service system according to the present invention, the bidirectional communication device preferably controls from a certain user terminal the configuration of screens to be displayed on the user terminals.

Consequently, the certain user terminal can be used as a chairperson terminal for effective services. For example, in a conference service, a chairperson modifies the configuration of screens to display in accordance with the proceeding. In an education service, an instructor can modify the configuration of the screens in accordance with the mode of communication.

In the multimedia information communication service system according to the present invention, the bidirectional communication device preferably controls from a certain user terminal the allocation of sounds of the respective users to be output on the user terminals.

Consequently, the certain user terminal can be used as a chairperson terminal for effective services. For example, in a conference service, a chairperson modifies the allocation of the attendants' voices in accordance with the proceeding. In an education service, an instructor can modify the allocation of the voices of the instructor and individual students in accordance with the mode of communication.

In the multimedia information communication service system according to the present invention, the bidirectional communication device preferably controls from the user terminals the configuration of screens to be displayed on the user terminals based on the magnitude of sound data transmitted.

This enables such operations as highlighting the screens of speakers and automatically switching to the screens of speakers for effective services.

In the multimedia information communication service system according to the present invention, the bidirectional communication device preferably includes a data conference function for sharing an application to be performed on the user terminals.

This enables sophisticated services in which the users use a certain application for cooperative work.

In the multimedia information communication service system according to the present invention, the bidirectional communication device preferably includes a chat function of providing bidirectional communications between the user terminals by text entry.

This enables text-based conversations between the users, so as to provide precision- and recordability-requiring services available.

In the multimedia information communication service system according to the present invention, the bidirectional communication device preferably modifies a quality of information to transmit in accordance with a communication band of the network.

Consequently, even when the communication band of the network is limited, the bidirectional communication function having quality corresponding to the communication band is maintained for optimum services.

In the multimedia information communication service system according to the present invention, the content delivery device preferably controls from the user terminals content replay.

Consequently, content replay can be controlled from the user terminals in accordance with the progress of service, thereby allowing various modes of services.

In the multimedia information communication service system according to the present invention, the content delivery device preferably includes a picture and sound link device for providing a live link of pictures and sounds.

Consequently, real-time pictures and sounds from other than the user terminals can be used to provide such services as conferences and education with field coverage.

In the multimedia information communication service system according to the present invention, the content delivery device preferably modifies a quality of information to transmit in accordance with a communication band of the network.

Consequently, even when the communication band is limited, the content delivery function having quality corresponding to the communication band is maintained for optimum services.

The multimedia information communication service system according to the present invention preferably further includes resource management device for managing availability of the bidirectional communication device and connections of the user terminals.

This facilitates determining service availability, thereby allowing more efficient service reception and automated service reservation.

The multimedia information communication service system according to the present invention preferably further includes accounting device for calculating service charges for users, the accounting device summarizes connect times of the user terminals used by the users and conducting charging.

It is therefore possible to summarize charges separately even if the connect times vary user by user.

The multimedia information communication service system according to the present invention preferably further includes accounting device for calculating service charges for users, the accounting device having the function of summarizing connect time of a user terminal used by predetermined one other than the users and conducting charging.

This enables charging corresponding to the time of service, for example, by an instructor in an education service, by a doctor in a medical service, by a lawyer in a legal consultation service, etc.

The multimedia information communication service system according to the present invention preferably further includes accounting device for calculating service charges for users, the-accounting device having the function of acquiring predetermined charge information on content to be provided by the content delivery device and conducting charging.

This realizes charging corresponding to the content delivered.

In the multimedia information communication service system according to the present invention, some or all of the user terminals are preferably connected over the Internet.

Consequently, users who have Internet-capable environment can participate in the service anytime.

A program for use on a user terminal of the multimedia information communication service system according to another preferred embodiment of the present invention includes a device for acquiring a TV picture and sound of the user terminal, a device for transmitting the TV picture and sound acquired, a device for receiving TV pictures and sounds from the bidirectional communication device, a device for receiving multimedia content from the content delivery device, and a device for creating a predetermined window to output the received TV pictures and sounds and the received multimedia content.

A computer-readable recording medium according to another preferred embodiment of the present invention includes a program for use on a user terminal of the multimedia information communication service system.

The above and other elements, characteristics, features, steps and advantages of the present invention will become clear from the following description of preferred embodiments taken in conjunction with the accompanying drawings.

### BRIEF DESCRIPTION OF THE DRAWINGS

FIG. 1 is a block diagram showing an information communication service center according to a preferred embodiment of the present invention;

FIG. 2 is a conceptual diagram showing a video conference function according to the preferred embodiment of the present invention;

FIG. 3 is a diagram showing the procedure for the video conference function according to the preferred embodiment of the present invention;

FIG. 4 is a conceptual diagram showing a data conference function according to the preferred embodiment of the present invention;

FIG. 5 is a conceptual diagram showing a content delivery function according to the preferred embodiment of the present invention;

FIG. 6 is a conceptual diagram showing the method of expressing delivery content in a scenario;

FIG. 7 is a chart showing an example of a scenario for use in the content delivery of the present invention;

FIG. 8 is a diagram showing the procedure for scenario-based content delivery;

FIG. 9 is a diagram showing the procedure for operation control on content under delivery;

FIG. 10 is a conceptual diagram showing a live link function according to the preferred embodiment of the present invention;

FIG. 11 is a diagram showing a content management database for automatic scenario creation;

FIG. 12 is a diagram showing a sample of description in a scenario dictionary;

FIG. 13 is a diagram showing the procedure for automatic scenario creation;

FIG. 14 is a diagram showing an example of screen display for situations where the conversation function by the bidirectional communication server is effected;

FIG. 15 is a diagram showing an example of screen display for the case of content delivery by the content delivery server;

FIG. 16 is a diagram showing an example of screen display for situations where a conversation is held with content delivery;

FIG. 17 is a chart showing examples of service configuration patterns for combining face-to-face services and automatic services;

FIG. 18 is a chart showing examples of combination of a plurality of services to be taken charge of by a single instructor;

FIG. 19 is a diagram showing an example of a membership information entry screen;

FIG. 20 is a diagram showing the procedure for the authentication and accounting function according to the preferred embodiment of the present invention;

FIG. 21 is a diagram showing an example of a bonus score inquiry screen;

FIG. 22 is a diagram showing an example of a karte entry screen; and

FIG. 23 is a block diagram showing a conventional information communication service system.

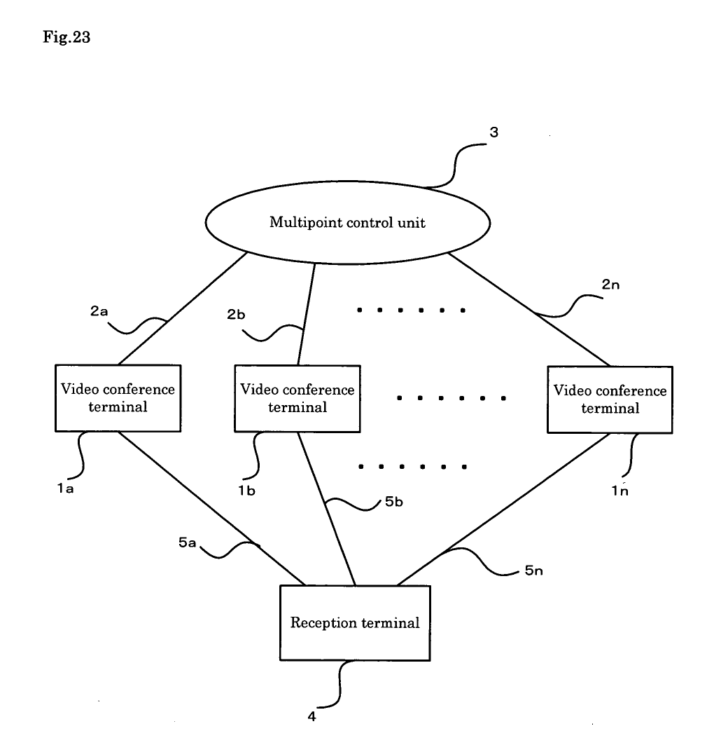

### DETAILED DESCRIPTION OF PREFERRED EMBODIMENTS

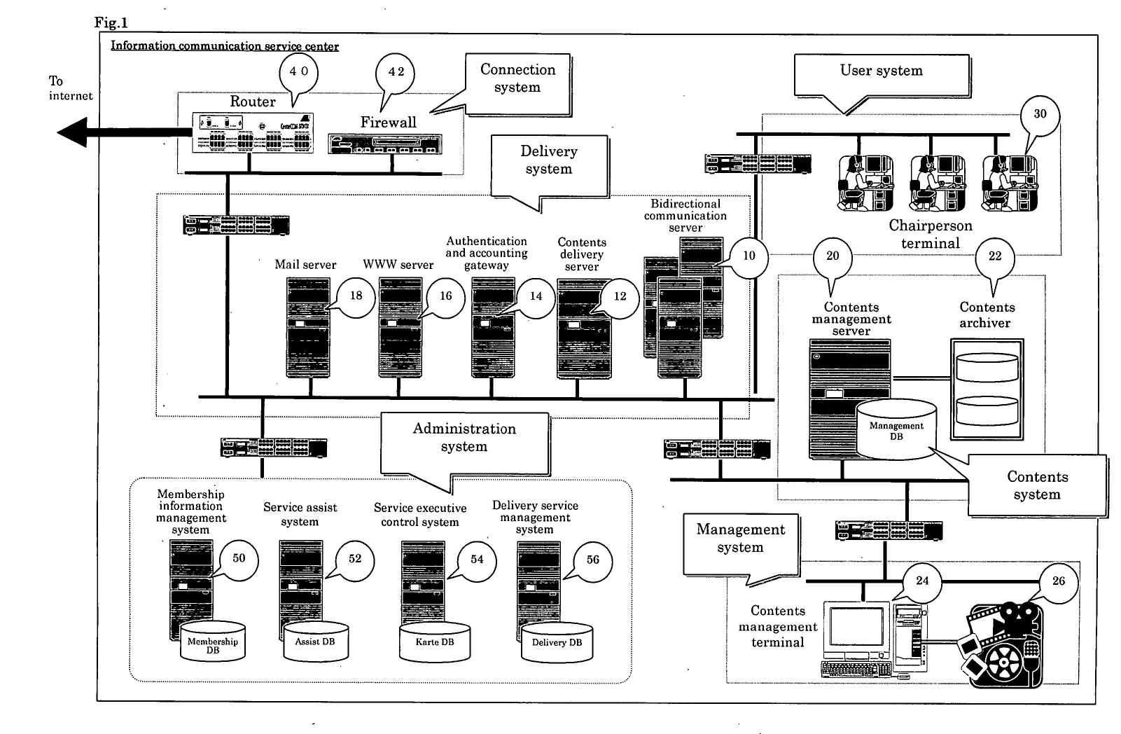

FIG. 1 is a block diagram showing an information communication service center according to a preferred embodiment of the multimedia information communication service system using communication lines according to the present invention. As shown in the diagram, the center is network-connected with the following subsystems: delivery system, content system, user system, connection system, and administration system.

The delivery system includes a bidirectional communication server 10, a content delivery server 12, an authentication and accounting gateway 14, a WWW server 16, and a mail server 18. The bidirectional communication server 10 provides bidirectional communication functions among a plurality of user terminals, using multimedia including TV pictures and sounds. The content delivery server 12 delivers content to the user terminals. The authentication and accounting gateway 14 provides authentication and accounting management in cooperation with administration system. The WWW server 16 delivers Web pages for use in authenticating users, selecting service menus, etc. The mail server 18 delivers various notifications, materials, and other mails to the users.

The content system includes a content management server 20, a content archiver 22, a content management terminal 24, and a picture and sound link unit 26. The content management server 20 registers and stores multimedia content, such as moving images, still images, sounds, text, and sound effects. The content archiver 22 contains material content. The content management terminal 24 provides registration and storing operations by the content administrator. The picture and sound link unit 26 links live pictures and sounds.

The user system includes chairperson terminals 30 which are user terminals installed in the center and used primarily by chairpersons. Each of the chairperson terminals 30 includes a TV camera and a microphone for capturing the picture and voice of a chairperson, and a computer having an interface function intended for the TV camera and microphone and a network connection function. The chairperson terminals 30 provide the function of transmitting the pictures and voices captured by the TV cameras and microphones, and the function of receiving multimedia information from the bidirectional communication server 10 and the content delivery server 12 and outputting the same to screens and speakers. The chairperson terminals 30 also provides the functions of selecting screen configuration and sound allocation on user terminals, and transmitting control signals intended to instruct operations for content delivery etc. to the bidirectional communication server 10 and the content delivery server 12.

The connection system includes a router 40 and a firewall 42. The router 40 provides an Internet connection. The firewall 42 prevents unauthorized entry from exterior for the sake of system protection.

The administration system includes a membership information management system 50, a service assist system 52, a service executive control system 54, and a delivery service management system 56. The membership information management system 50 manages information of the members to be served. The service assist system 52 provides a smooth service provision. The service executive control system 54 performs executive control of services. The delivery service management system 56 exercises centralized control on the mail delivery to the registered members.

Now, although not shown in the diagram, attendant terminals, or user terminals to be used by ordinary attendants, each include a TV camera and a microphone for capturing the picture and voice of the attendant, and a personal computer having an interface function intended for the TV camera and microphone and an Internet connection function. The attendant terminals can access the WWW server 16 in the center to receive information communication services provided by the center. It should be noted that the attendant terminals are basically the same as the foregoing chairperson terminals 30 in operation except that they are connected with the center over the Internet.

As used in the following description, the “user terminals” refer to both the attendant terminals and the chairperson terminals 30.

Now, description will be given of the functions and the procedures to be provided by the center. Bidirectional Communication Functions

Initially, description will be given of bidirectional communication functions to be provided by the bidirectional communication server 10.

1. Video Conference Function

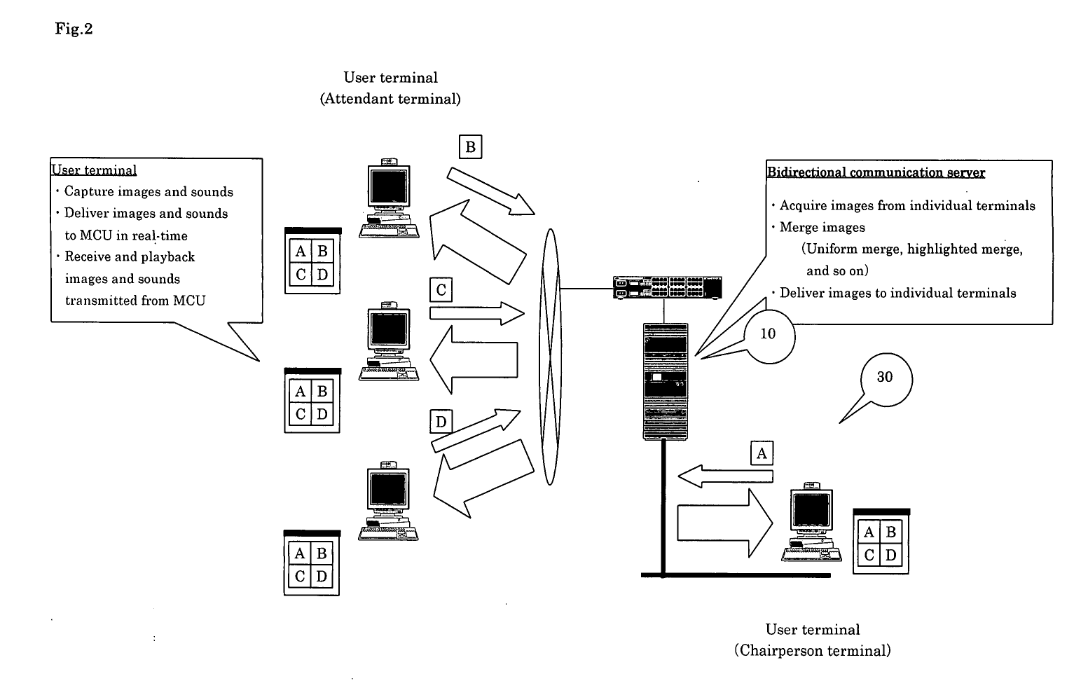

FIG. 2 is a conceptual diagram showing a video conference function to be provided by the bidirectional communication server 10. As shown in the diagram, the video conference function is to provide one-to-one, one-to-many, or many-to-many bidirectional communications using pictures and sounds captured by the TV cameras and microphones that are connected to the respective user terminals.

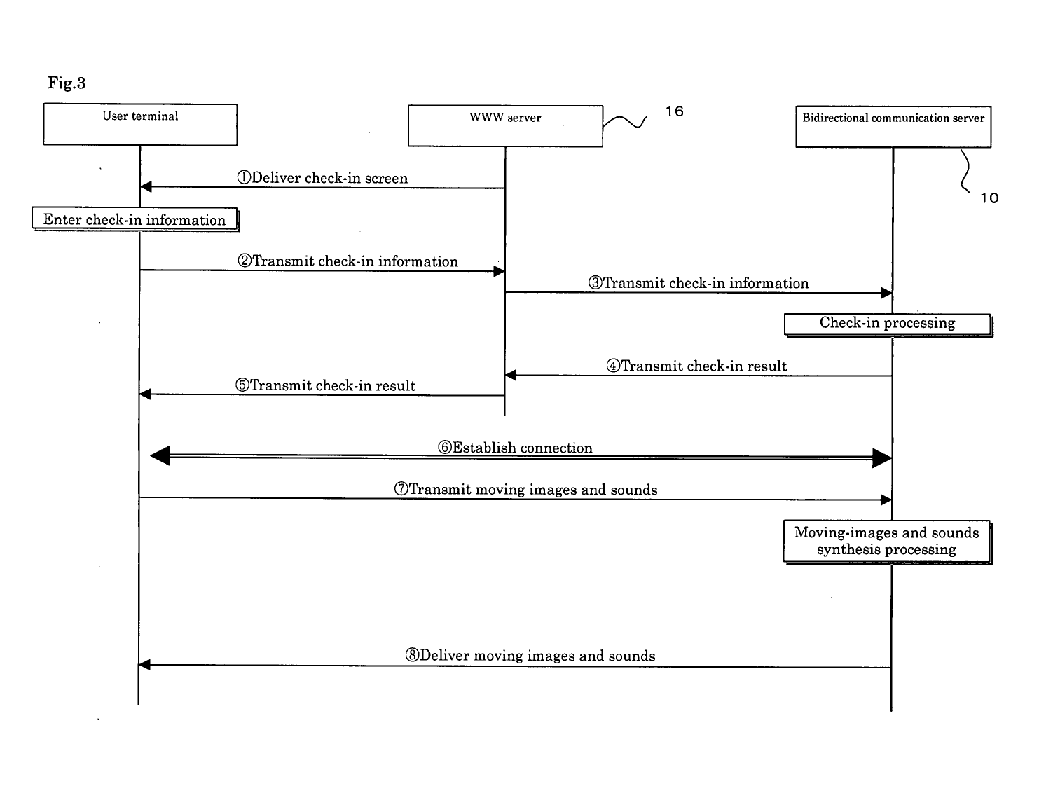

FIG. 3 shows the procedure for the video conference function. User terminals access the WWW server 16 to have a check-in screen delivered. Based on this, the users enter check-in information, and the user terminals transmit the check-in information to the bidirectional communication server 10 via the WWW server 16. Receiving the check-in information, the bidirectional communication server 10 performs check-in processing and returns the check-in results to the respective user terminals via the WWW server 16. This establishes connections. The individual user terminals capture pictures from the TV cameras and sounds from the microphones, and transmit the captured pictures and sounds to the bidirectional communication server 10 in real time. The bidirectional communication server 10 receives the pictures and sounds transmitted from the individual user terminals, synthesizes the received pictures and sounds into pictures and sounds to be delivered to the respective user terminals, and delivers the synthesized pictures and sounds to the user terminals. The individual user terminals receive the pictures and sounds delivered from the bidirectional communication server 10, create dedicated window on-screen to display the received pictures, and output the received sounds to their speakers.

The bidirectional communication server 10 thus provides a conversation function among the user terminals, using pictures and sounds. While the conversation function of the present system is either one-to-one or many-to-many, one-to-many service is also available if settings are made at the time of check-in so as to preclude delivery of pictures and sounds other than those from a certain user terminal (for example, a chairperson terminal 30).

Buttons for specifying the mode of synthesis of pictures and sounds appear on the screen of the chairperson terminal 30. The chairperson operates these buttons to transmit the information to the bidirectional communication server 10 such that a uniform merge for synthesizing the pictures and voices of the users uniformly and a highlighted merge for highlighting the pictures and voices of certain users is selected. For example, when a uniform merge is selected in a four-user conference, the screen is split into four equal sections while the TV pictures of the four are synthesized into a single screen and the sounds of the four are mixed evenly before delivery. When a highlighted merge is selected, the pictures and voices of designated users are selectively delivered. Alternatively, the size of the pictures and volume of the voices of the designated users can be increased and the size of the pictures and volume of the voices of the other users can be decreased before delivery.

Incidentally, in the foregoing preferred embodiment, both of the modes of synthesis of pictures and sounds are designated by a button operation from the chairperson terminal at the same time. Nevertheless, buttons for pictures and sounds may be provided separately to permit separate specifications. In this case, for example, it is possible to check attendants' expressions in response to the voices of others.

In the foregoing preferred embodiment, the bidirectional communication server 10 synthesizes pictures and sounds before delivery to the user terminals. Nevertheless, the pictures and sounds of user terminals may be delivered to other user terminals individually such that the respective user terminals create separate windows to display the received pictures along with their own pictures and replay sounds separately. In this case, the user terminals need not receive their own pictures and sounds delivered back to them. This reduces the load on the communication lines. In addition, the users can arrange the screen configuration and sound allocation freely according to their own tastes.

Here, the bidirectional communication server 10 delivers picture and sound control commands from the chairperson terminal 30 to the individual user terminals such that the user terminals set the screen configuration and sound allocation based on the control signals.

In the foregoing preferred embodiment, the chairperson terminal 30 alone is provided with the function of controlling the screen configuration and sound allocation on each user terminal. Nevertheless, the attendant terminals may also be given the function of controlling the screen configuration and sound allocation on each user terminal by the same method. Consequently, even in the absence of one who is in charge of the chairperson terminal 30, a chairperson can be selected from among the attendants. The bidirectional communication server 10 may be provided with a flag for granting the chairpersonship to a user terminal, such that control commands from the flagged user terminal are accepted. This makes services available using any one of the user terminals as the chairperson terminal.

Furthermore, the screen configuration of the respective user terminals may be controlled based on the magnitudes of sound transmitted from the individual user terminals. More specifically, for example, the magnitudes of the sound transmitted from the respective user terminals can be detected to achieve screen-configuration control functions such that the images of users beyond a certain level are highlighted, and that only the images of users beyond a certain level are displayed selectively. Here, the magnitudes of the sound may be determined in terms of instantaneous values or an average value over a certain period of time.

In the case of the method where the bidirectional communication server 10 synthesizes the pictures and sounds of the individual user terminals before delivery to the user terminals, the bidirectional communication server 10 only needs to detect the magnitudes of the sound information received from the respective user terminals and control the picture synthesis. On the other hand, with the method where the bidirectional communication server 10 delivers the pictures and sounds of the individual user terminals to the user terminals separately, the destination user terminals may detect the magnitudes of the sound information received from the individual user terminals and control screen configuration, or the bidirectional communication server 10 may detect the magnitudes of the sound received from the individual user terminals and deliver screen-configuration control signals to the user terminals so that the respective user terminals control the screen configuration based on the control signals.

Additional functions may also be provided including a voice control function of delaying image display and/or sound output slightly for automatic cue, and an anti-trip function of precluding control functions from being activated by speaker sounds.

The transmission of the pictures and sounds by the respective user terminals and the delivery of the pictures and sounds by the bidirectional communication server 10 may be modified in quality depending on the communication band of the network. To be more specific, a function of detecting the available communication band and lowering the frame rate of the pictures according to the communication band when the band is limited is provided. Another function may be provided for lowering the sampling rate and the quantization bit rate of the sounds if the available communication band is narrow. The communication band may be detected by such device as packet exchange at the stage of negotiation prior to communication, or by sending packets for checking the communication band during communication. Consequently, even when the communication band of the network is limited, the bidirectional conversation functions having quality corresponding to the communication band is maintained for optimum services.

2. Data Conference Function

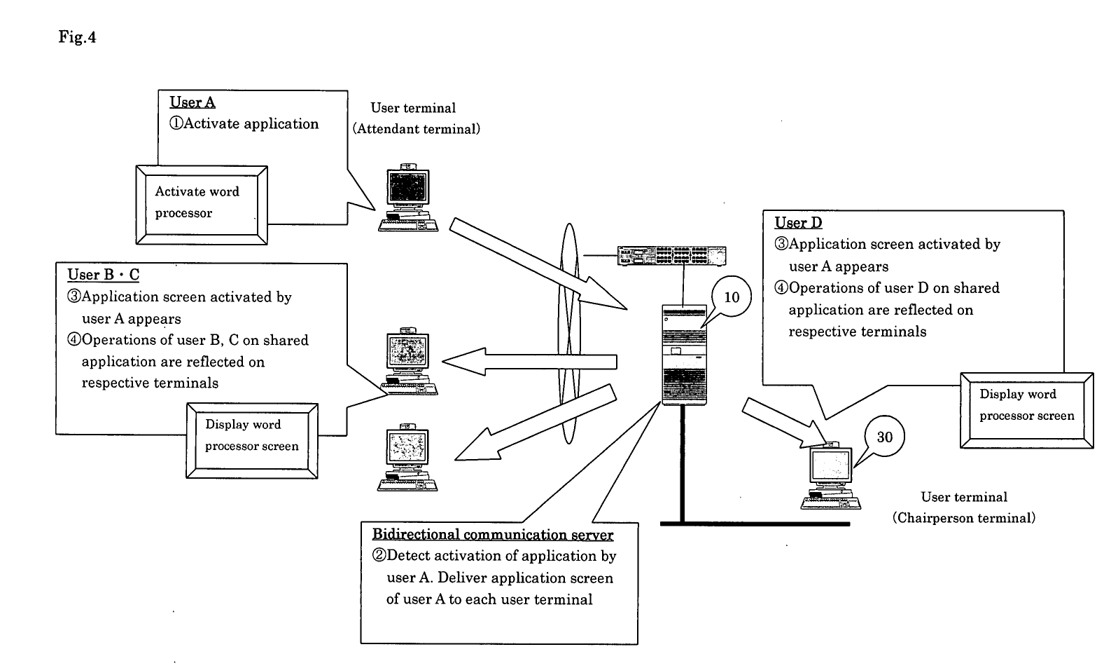

FIG. 4 is a conceptual diagram showing a data conference function to be provided by the bidirectional communication server 10. The data conference function enables application-based cooperative work by sharing applications installed on the individual user terminals or applications on WWW browsers.

For example, as shown in the diagram, when a shared application is activated on the terminal of user A, the terminal of user A transmits the activated shared application screen to the bidirectional communication server 10. The bidirectional communication server 10 delivers the shared application screen from the terminal of user A to the terminals of other users B, C, and D. The terminals of users B, C, and D display the shared application screen delivered from the bidirectional communication server 10. This permits the terminals of users B, C, and D to operate the shared application. Operations are fed back to the terminal of user A via the bidirectional communication server 10. Sophisticated services are thus be provided since all the users collaborates by using a word processor, spreadsheet, clip art, and other application programs. For example, it is possible to create a whiteboard on which drawings and characters are written by mouse, and hold a discussion among all the members while writing on this whiteboard.

3. Chat Function

Description will now be given of a chat function to be provided by the bidirectional communication server 10. The chat function provides one-to-one, one-to-many, or many-to-many bidirectional communication by text entries from the user terminals. When a chat program is activated on one of the user terminals, the information is posted to the other user terminals via the bidirectional communication server 10, and the chat screen also appears on the other user's display. When text is entered from any of the user terminals, the entered text is posted to the other user terminals via the bidirectional communication server 10, and the entered text is also displayed on the other user terminals. This enables text-based conversations between the users, making precision- and recordability-requiring services available.

Incidentally, the screen-configuration control function of the chairperson terminal 30 (or the chairpersonship-flagged user terminal or the like) described above may also include a function of controlling the screens of the data conference function and chat function in the same manner. This allows the chairperson or the other to exercise control for smooth multimedia bidirectional communication services allover. Content Delivery Function

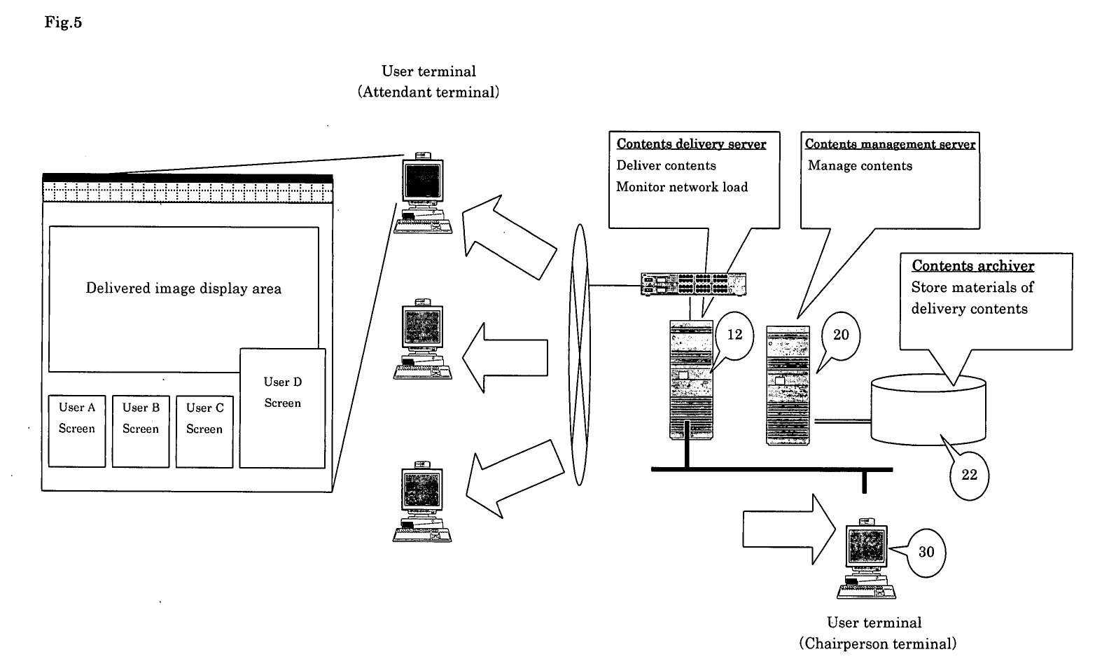

Next, a description will be given of the functions and procedure that the content delivery server 12 provides. FIG. 5 is a conceptual diagram showing a content delivery function to be provided by the information communication service system. With the content delivery function, the content delivery server 12 delivers, to the user terminals, multimedia content such as moving images, still images, sounds, text, and application data that are recorded on the content archiver 22 managed by the content management server 20.

In the information communication service system of the present invention, the material of the content to be delivered, or material content, are recorded on the content archiver 22 and combined into content for delivery. For this purpose, a scenario defines a combination of material content along the time axis.

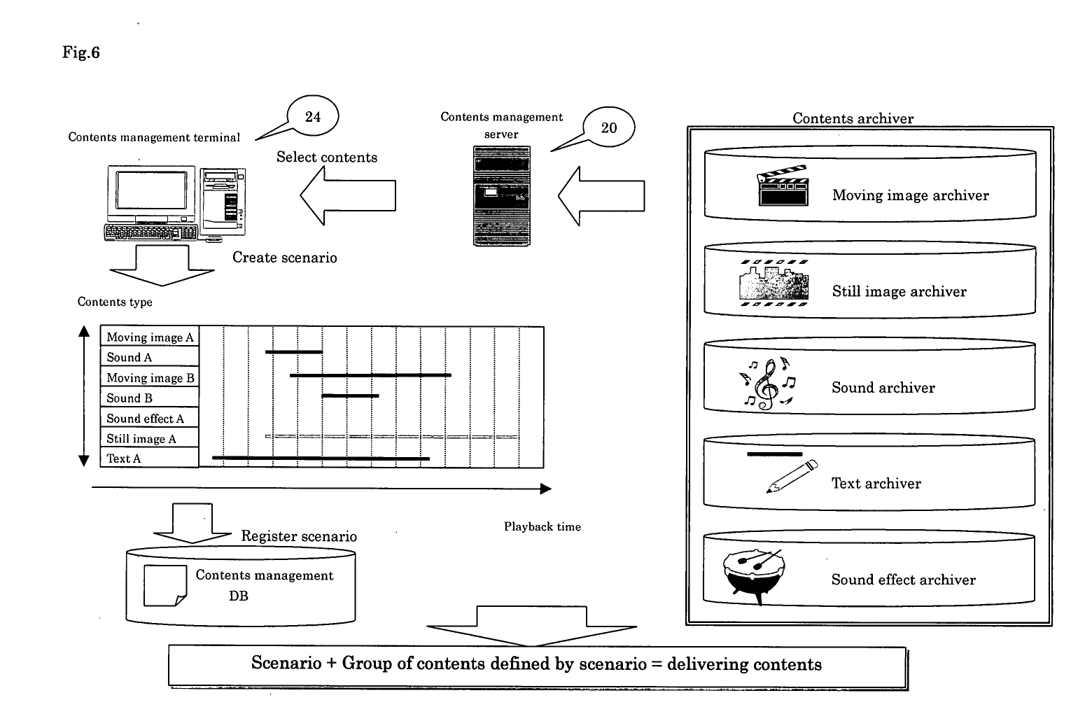

FIG. 6 is a conceptual diagram showing the method of expressing delivery content by a scenario. More specifically, the delivery content creator previously registers the material content necessary for services into the content archiver 22 via the content management server 20 by using the content management terminal 24. At the time of creation of the delivery content, the material content to be combined into the delivery content is selected out of the material content recorded on the content archiver 22. As shown in the diagram, by using a chart which indicates the replay times of the material content, or a replay chart, the material content to be combined is registered along the time axis to create a scenario. The created scenario is registered into a database of the content management server 20.

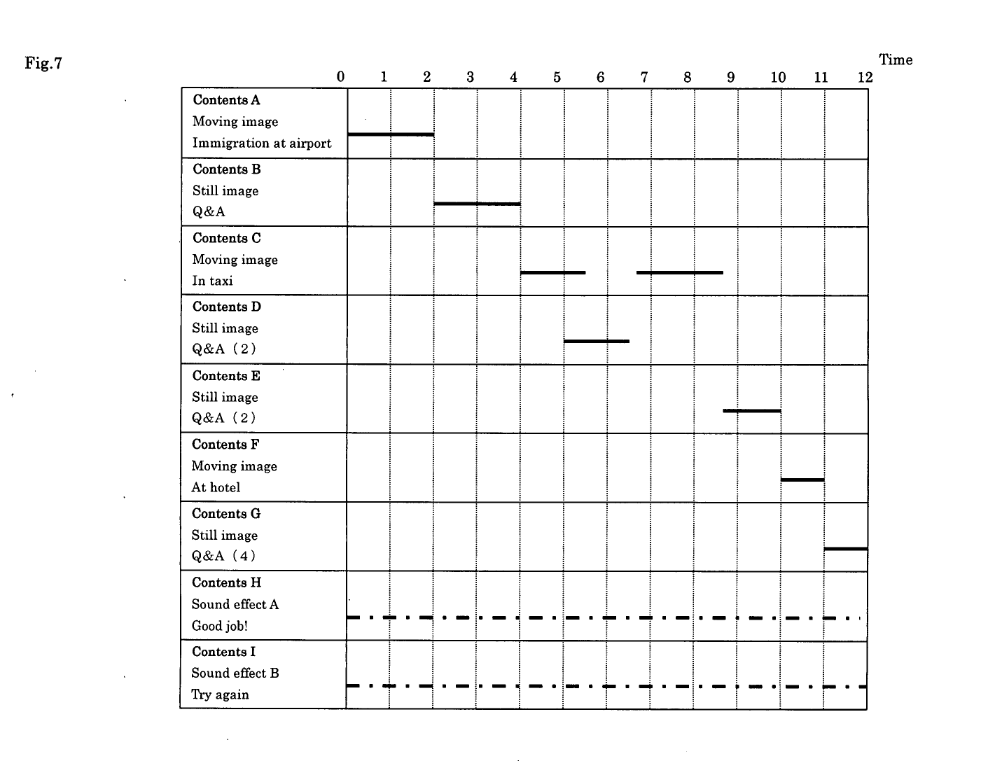

FIG. 7 shows an example of the scenario created. As shown, a combination of moving images, still images, sound effects, and other information is arranged along the time axis to define a single piece of delivery content. Here, the dot-line expressions represent ones which are replayed by operations from a certain terminal at any time within a specific period. Consequently, for example, the chairperson can replay sound effects, subtitles, etc. at any time within a specific period for effective presentation.

### Information Included in Scenario

A scenario includes the following information in order to achieve delivery of a combination of material content and allow flexible administration.

1. Definition of Delivery Content

Information as to the entire content for delivery is defined.

(1) Delivery Content Attribute Information

The delivery content attribute information describes creator, creation date and time, title, genre, and additional information. This permits retrieval of the delivery content (scenario).

(2) Used Material Content Information

Used material content information includes specifies material content to be used in the delivery content.

2. Definition of Material Content

Information as to each piece of the material content to be used in the delivery content is defined.

(1) Material Content Attribute Information

Material content attribute information describes creator, creation date and time, title, genre, and additional information. This allows retrieval of the delivery content (scenario) based on the attributes of the material content used.

(2) Material Content Type Information

Material content type information specifies the type of material content (moving image/still image/sound/text/application data). Here, the filename extension of the designated material content may be used for specification.

(3) Replay Time Specification Information

Replay time specification information specifies the replay start time and replay end time of the material content in terms of relative time within the delivery content. This specifies the replay period of the material content within the delivery content. A replay time may be used instead of the replay end time.

Here, the replay end time/replay time may be omitted if the material content has a fixed replay time.

(4) Replay Mode Specification Information

Replay mode specification information specifies the mode of replay of the material content between automatic replay and manual replay. In the case of manual replay, the content is replayed under the instruction from the user terminal. For example, this makes it possible to replay sound effects, subtitles, and the like at arbitrary timing for effective presentation.

(5) Replay Application Specification Information

Replay application specification information specifies which application is used to replay the material content. The application for replaying the material content is thus defined by the scenario. Here, the filename extension of the designated material content may be used for specification.

(6) Replay Screen Specification Information

Replay screen specification information specifies the position and size of the material content replayed on-screen. The position and size of the material content under replay on-screen can thus be specified for effective presentation. For sounds, an icon to appear on-screen and the position thereof may be specified.

(7) Chairperson Terminal Operation Specification Information

Chairperson terminal operation specification information specifies operations (play/stop/pause/fast forward/rewind, etc.) available for the chairperson terminal 30 (or a chairpersonship-flagged user terminal) during the replay of the material content. The chairperson can thus control content replay in accordance with the progress of the service, allowing various service modes.

(8) Attendant Terminal Operation Specification Information

Attendant terminal operation specification information specifies operations (play/stop/pause/fast forward/rewind) available for the user terminal during the replay of the material content. This allows attendants to replay the content according to their own paces.

(9) Location Specification Information

Location specification information specifies the location where the material content is stored. This makes it possible to replay the material content by designating a protocol and server name even if the user terminal does not contain the material content. Material content managed in a plurality of centers can also be used for content delivery. Moreover, the picture and sound link unit 26 can achieve a live link when the content management server 20 is specified as the location.

(10) Replay Part Specification Information

Replay part specification information specifies the start time and end time of the portion of the material content to replay. This allows specifications for partial replay of the material content. A replay time may be used instead of the end time.

### Method of Scenario-Based Content Delivery

Next, description will be given of the method of delivering content by using the scenario described above.

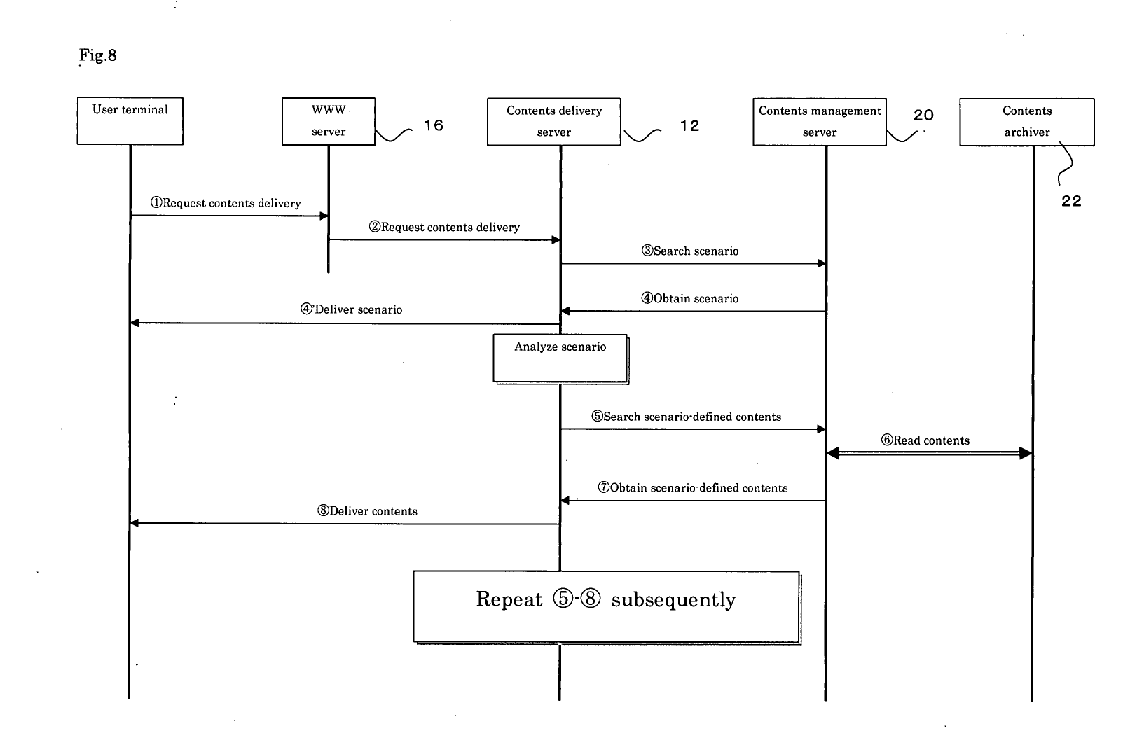

FIG. 8 shows the procedure for scenario-based content delivery. The content delivery server 12 receives a content delivery request from a user terminal via the WWW server 16, and obtains the scenario from the content management server 20. The content delivery server 12 also delivers the obtained scenario to the user terminal for controlling the user terminal. Subsequently, the content delivery server 12 analyzes the scenario, retrieves the material content defined in the scenario from the content archiver 22 via the content management server 20 in succession along the time axis, and delivers the same to the user terminal. These operations are performed on all of the material content defined in the scenario to complete the delivery of the delivery content.

The destination terminal receives the delivered content, and replays the same by using designated applications according to the description of the scenario, such that images are displayed in the specified positions on-screen. When a certain operation is specified by the chairperson terminal 30 or an attendant terminal, a predetermined replay control is provided under the command from that terminal.

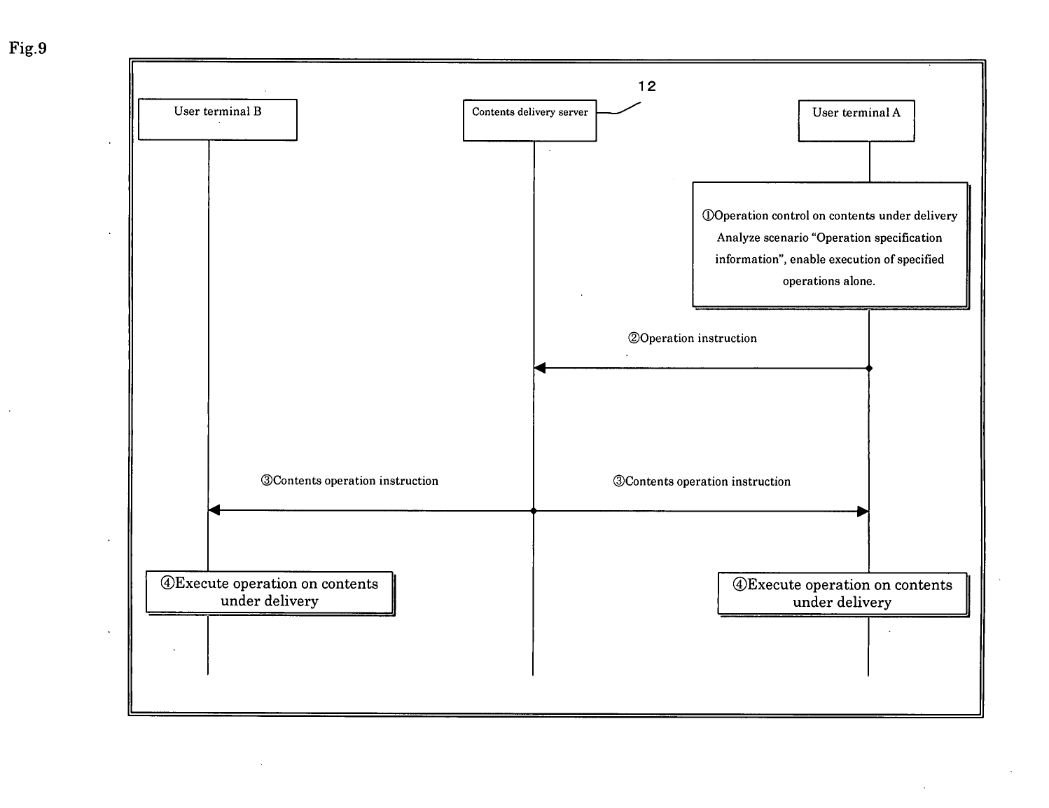

Now, description will be given of the synchronization of replay of material content between terminals. FIG. 9 shows the procedure for operation control of content under delivery. As shown in the diagram, when an operation instruction for a possible operation is issued from an operable terminal based on the operation specification information of the scenario, it is posted to the content delivery server 12. The content delivery server 12 delivers the operation instruction to each terminal. In order to perform replay based on the operation instruction, all of the terminals replay the material content in synchronization with each other.

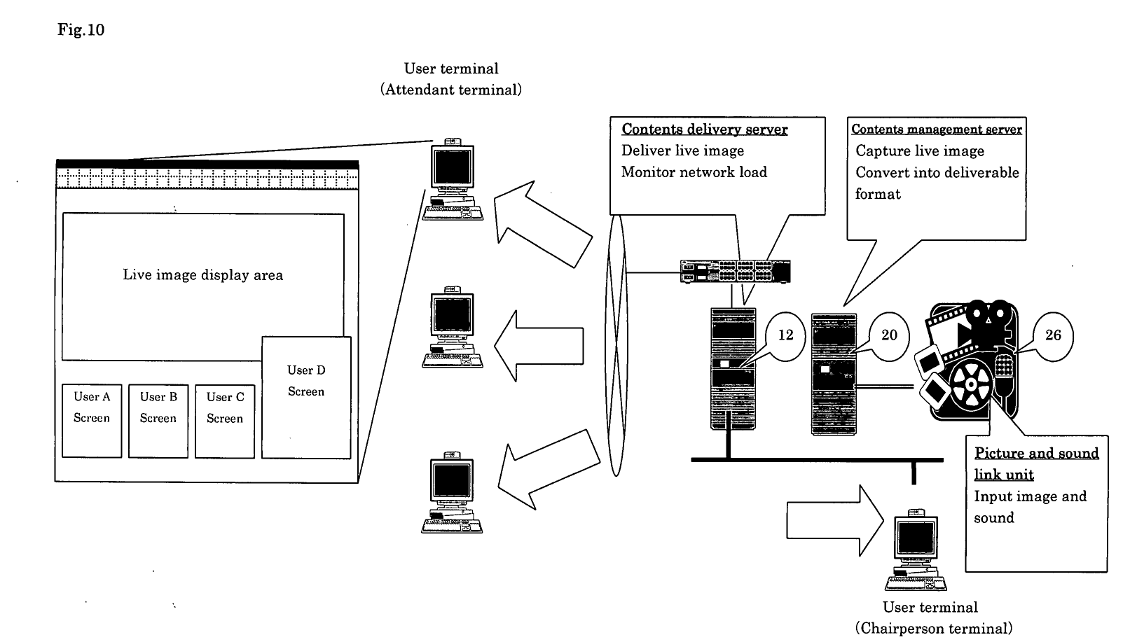

The content management server 20 is provided with the picture and sound link unit 26, and captures picture signals and sounds signals connected thereto and converts the same into deliverable formats. This permits a real-time link of live pictures and sounds to the content to be delivered. FIG. 10 is a conceptual diagram showing the live link function.

When the content to be delivered includes moving images, streaming delivery is performed. Like the bidirectional communication server 10, the content management server 20 modifies the frame rate of the moving images according to the communication band of the network. The content management server 20 may also modifies the sampling rate or quantizing bit rate of sounds according to the communication band of the network if the content to be delivered are sounds. Consequently, even when the communication band of the network is limited, the content delivery function is maintained in quality corresponding to the communication band to provide optimum services.

In the foregoing preferred embodiment, the content delivery server 12 initially transmits the scenario to the destination terminal(s), and then delivers the material content at the respective replay times defined in the scenario such that the destination terminal(s) performs replay based on the scenario. Nevertheless, the destination terminal(s) may issue requests based on the scenario that the content delivery server 12 delivers necessary material content. In this case, if identical material content is used repeatedly, the material content delivered previously is reused to reduce the network load.

The content delivery server 12 may deliver images and sounds that are synthesized according to the scenario, instead of delivering the separate material content to the destination terminal(s). This facilitates such operations as superimposing subtitles on moving images and still images. This also reduces the load on the destination terminal(s), however, with limitations to the operation flexibility in the destination terminal(s). A method for delivering separate material content or synthesized material content is selected depending on the network load and the service content. Both types of content may be delivered in combination, and replayed in respective separate windows on the destination-terminal side. This makes it possible to provide a content delivery function of extremely high flexibility, reducing the network load.

The scenario described above may be written in XML or other description languages. This permits the individual terminals to read the scenario with their browsers, such that material content is selected along the time axis and replayed automatically by plug-in applications of the browsers.

### Method of Scenario Creation

Next, description will be given of the method of creating the scenario described above.

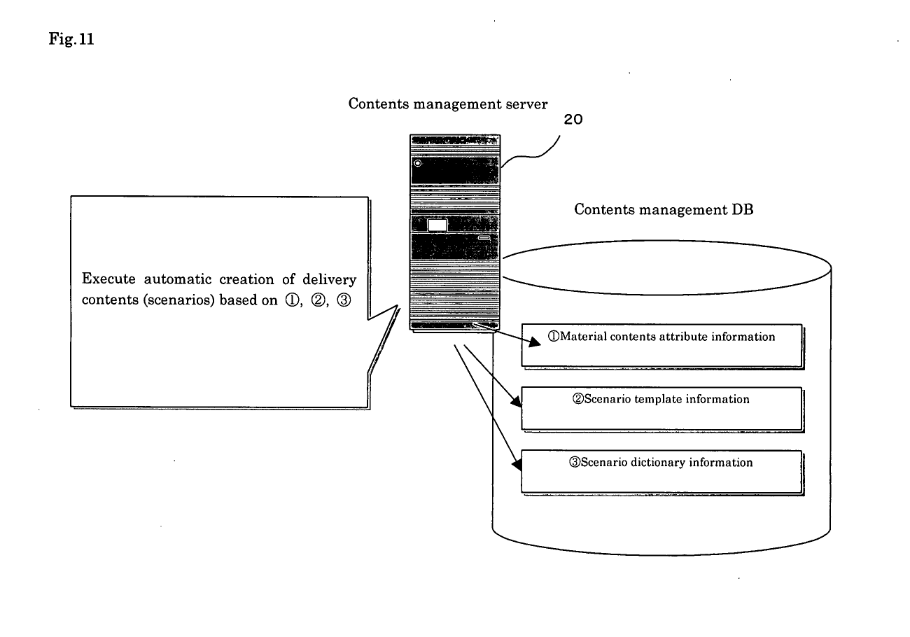

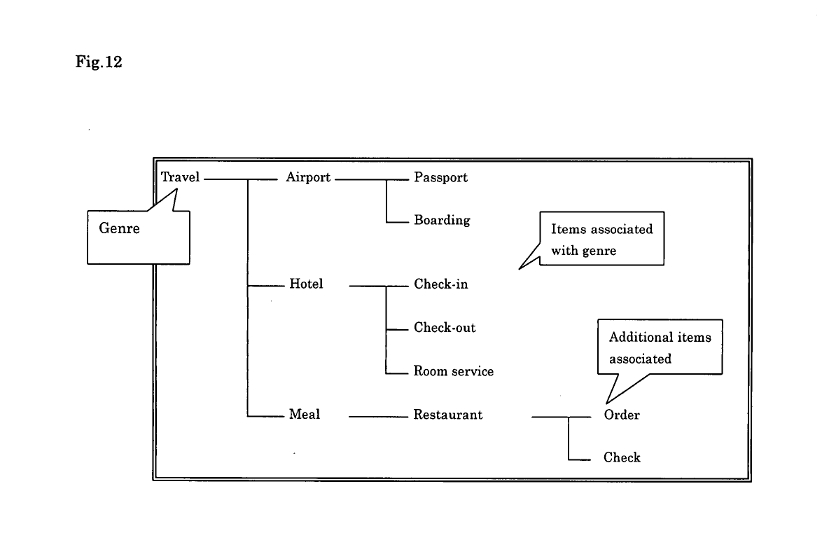

In this information communication service center, as shown in FIG. 11, the content management database of the content management server 20 contains attribute information, scenario dictionaries, and scenario templates. The attribute information refers to the material content that is stored in the content archiver 22. The scenario dictionaries show the relationship of the types of materials, or genres, with associated information. The scenario templates describe basic configuration patterns of scenarios. Then, the content management server 20 creates scenarios automatically based on this information. FIG. 12 shows a sample of a description in a scenario dictionary. As shown in the diagram, associated information for a single genre is written in tree form. Such scenario dictionaries are prepared in advance so as to cover the attribute information of the registered material content. The scenario templates describe genres, replay time, and the numbers of pieces of material content, as well as the attribute information, type information, replay time information, operation information, and other information of specified material content. The scenario templates are created and registered for necessary patterns in advance.

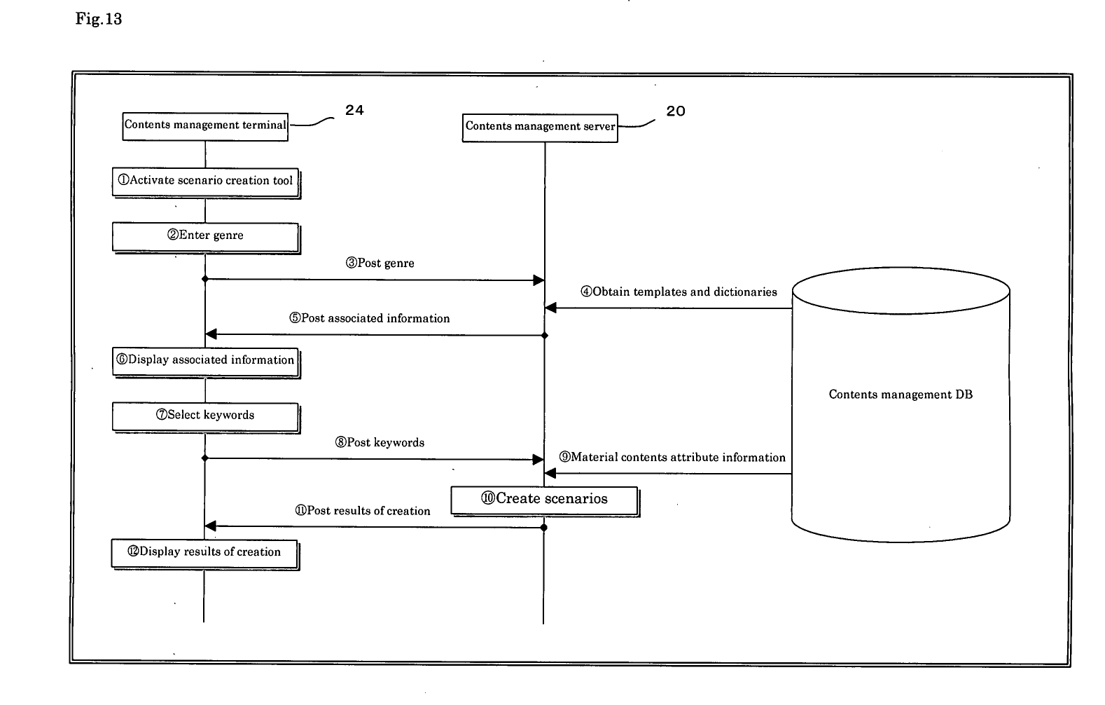

FIG. 13 shows the procedure for creating scenarios automatically by using the content management database mentioned above. The scenario creator activates a scenario creation tool from the content management terminal 24. When a genre is entered by the scenario creator, the content management terminal 24 posts it to the content management server 20. The content management server 20 retrieves scenario templates and a scenario dictionary conforming to the posted genre from the content management database. It also retrieves associated information from the scenario dictionary based on the genre and posts it to the content management terminal 24. The content management terminal 24 displays the associated information posted, and posts keywords that are entered by the scenario creator based on the display to the content management server 20. The content management server 20 retrieves the material content that conforms with the scenario templates based on the keywords posted, and obtains attribute information thereof. The content management server 20 creates scenarios by transcribing the obtained attribute information of the material content into the corresponding positions of the scenario templates, and posts the results to the content management terminal 24. The content management terminal 24 displays the results, modifies and edits the same if needed, and registers the completed scenarios into the content management database of the content management server 20.

As described above, the scenarios are created automatically in this information communication service system, and new content including hot topics is rapidly incorporated.

In the foregoing preferred embodiment, the scenario templates are selected by entering a genre alone. It is also possible, however, to designate the replay time or the ratios of content types in the replay content. Moreover, in order to inform the scenario creator of possible genres, replay times, and content ratios in advance, information about the registered scenario templates may be displayed such that selections are made from the same.

In the foregoing preferred embodiment, the scenarios are created automatically by using the scenario dictionaries which describe the relationship between genres and associated information, and scenario templates which describe scenario configuration patterns for creating scenarios. However, it is not required that the scenarios be created automatically. The scenario creator may enter keywords, retrieve related material content based on the same, and write the attribute information of the retrieved material content in the form of scenario data. In this case, necessary material content is retrieved quickly so as to improve the efficiency of scenario creation. Incidentally, the attribute information of the material content is written into scenario data by such device as a text editor.

The scenario dictionaries may be used alone to retrieve associated information based on the genre entry. Then, the material content is retrieved based on the associated information, and the attribute information of the retrieved material content is written into scenario data. Necessary material content is thus retrieved quicker than in the case of entering keywords, which further improves the efficiency of scenario creation.

In addition, the replay time specification information of the material content may be set using a replay chart which shows the replay periods of the respective pieces of material content. For example, as shown in FIG. 7, a minimum unit time for replaying material content is determined in advance such that the replay time specification information is set by selecting frames for replaying the material content on-screen. This facilitates setting the replay time specification information of the material content and clarifies the interrelationship among the replay periods of the respective pieces of material content, which enables effective content creation.

Scenario templates may be selected based on the genre entry among scenario templates. Here, a list of material content conforming thereto is displayed, and desired material content is selected from the list. This automatic retrieval of material content conforming to scenario templates facilitates combining the material content. The attribute information of the material content may be transcribed to the scenario data automatically so as to dramatically improve the efficiency of scenario creation.

While the foregoing preferred embodiment describes the case where the scenario templates describing basic scenario patterns are created in advance, previously registered scenarios may be used as scenario templates. This makes it possible to create scenarios without preparing scenario templates in advance. This also facilitates creating scenarios of modified content easily based on the scenarios registered previously.

Now, description-will be given of the screen display on a user terminal under information communication service using the bidirectional communication functions and the content delivery function.

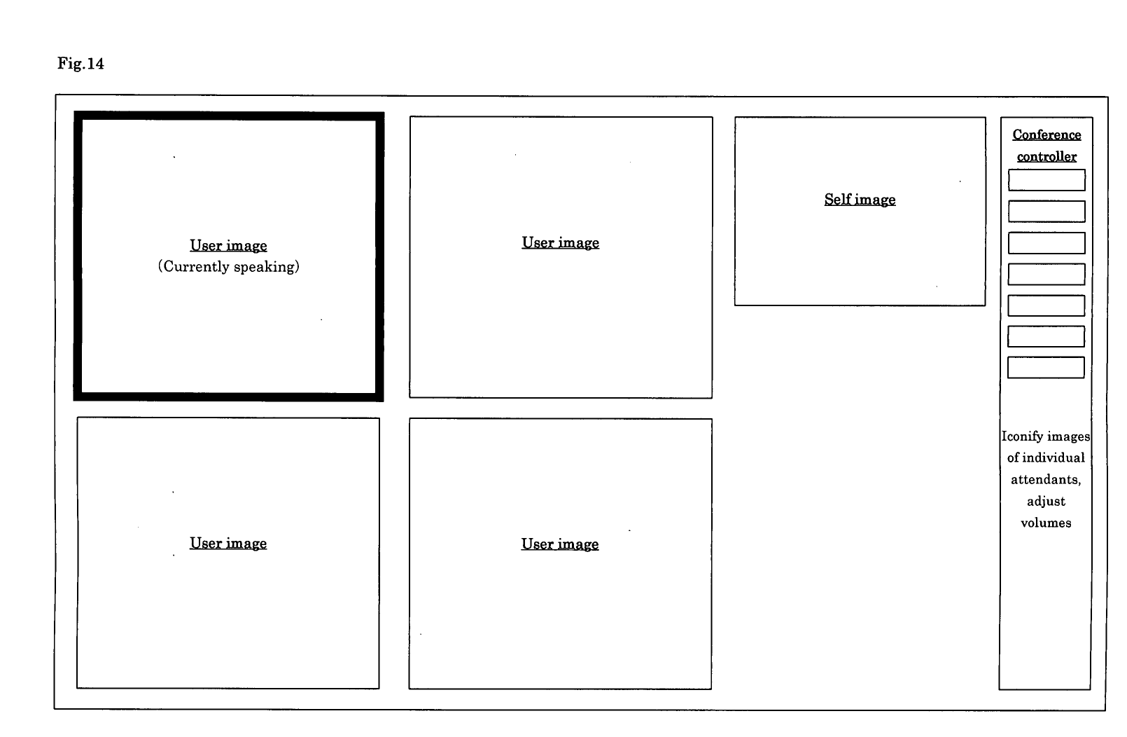

FIG. 14 shows an example of a screen display when the conversation function of the bidirectional communication server 10 is used alone. This example of the screen display is for a situation with five users including the chairperson. Windows for displaying the images of the other users and a window for displaying the image of the user himself/herself are created on-screen. Here, the screen includes buttons for controlling the video conference function. These buttons are used to perform the above-described controls of screen configuration, sound allocation, etc. As mentioned previously, the windows of users currently speaking are highlighted.

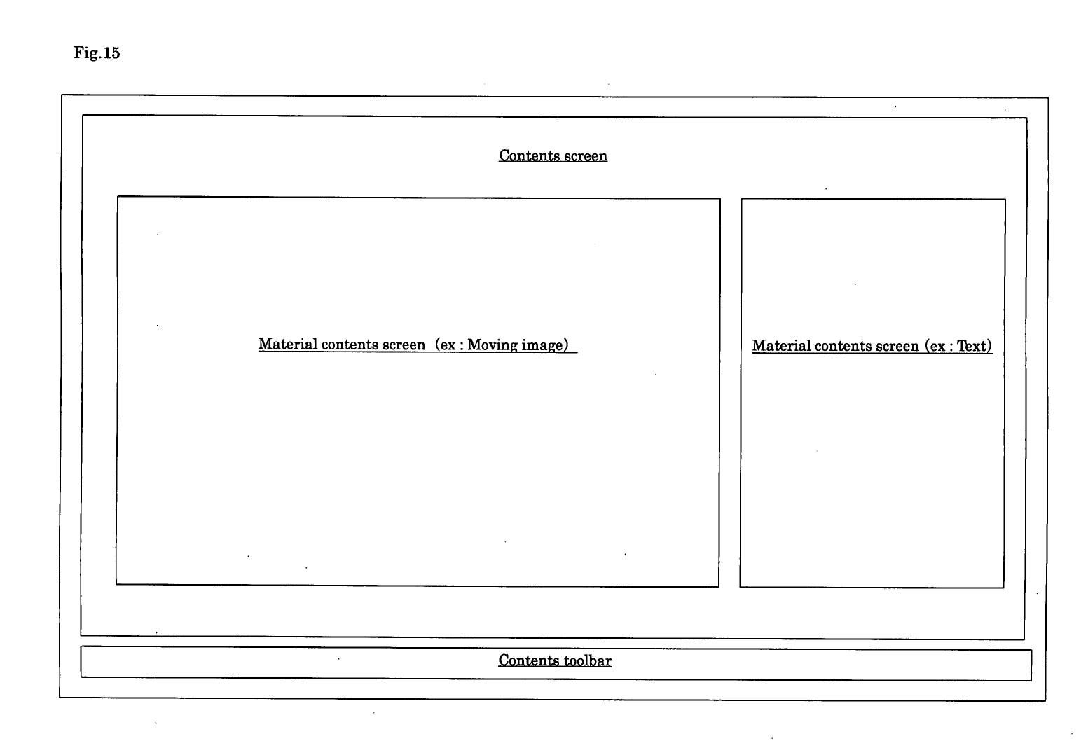

FIG. 15 shows an example of a screen display when content delivery by the content delivery server 12 is performed alone. Here, a moving-image window and a text window are created and displayed separately. Nevertheless, the windows may be synthesized on the content-delivery side and transmitted as a subtitled display.

A content toolbar is also provided, which is displayed as active when operable for content play, stop, pause, fast forward, rewind, etc., for example. These operations are made based on the operation specification information of the scenario described above.

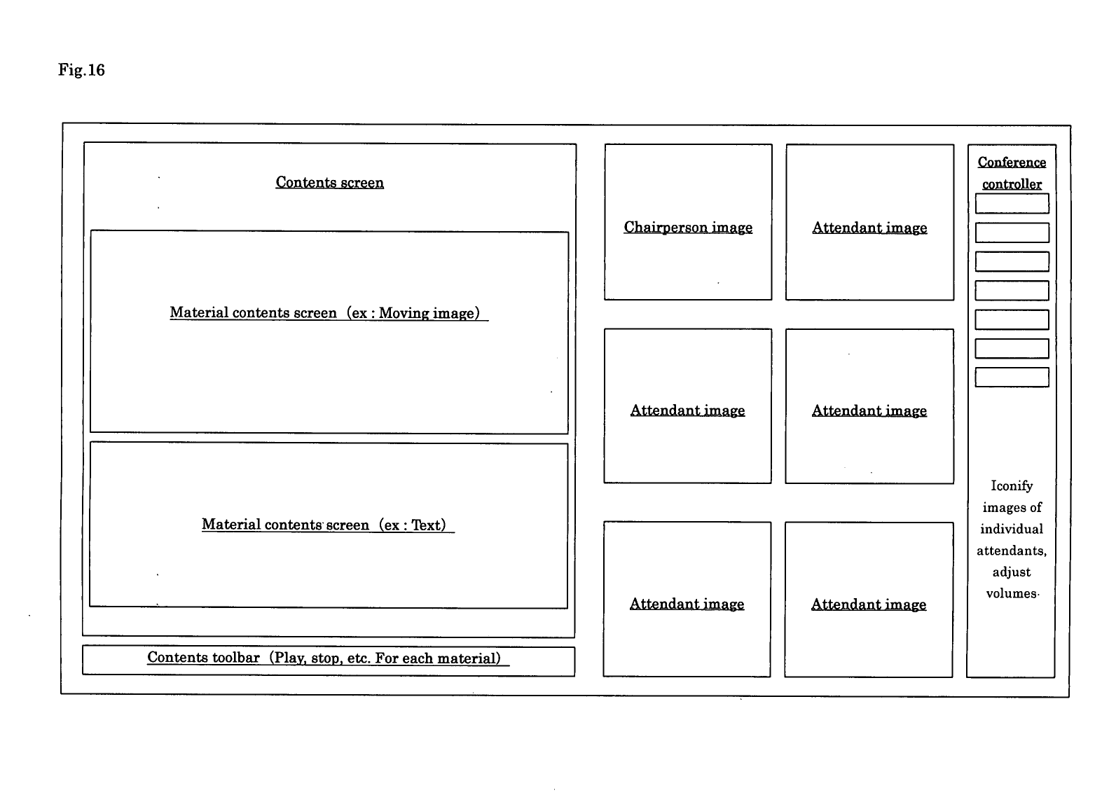

FIG. 16 shows an example of a screen display when conversations via the bidirectional communication server 10 are provided under content delivery by the content delivery server 12. As shown, the attendants can face one another while receiving content delivery for effective communication. Here, it is also possible to operate the conference control buttons for screen display and the toolbar for content replay.

### Mode of Service Provision

Next, description will be given of the modes of services that are provided by the system of the present preferred embodiment. This information communication service system includes both the bidirectional communication functions and the content delivery function, and thus, provided the following two modes of services.

1. Face-to-Face Service

In the presence of a chairperson, attendants conduct conversations with the chairperson via the bidirectional communication server 10, under content delivery service by the content delivery server 12, if necessary.

2. Automatic Service

In the absence of a chairperson, attendants receive content delivery service by the content delivery server 12 independently.

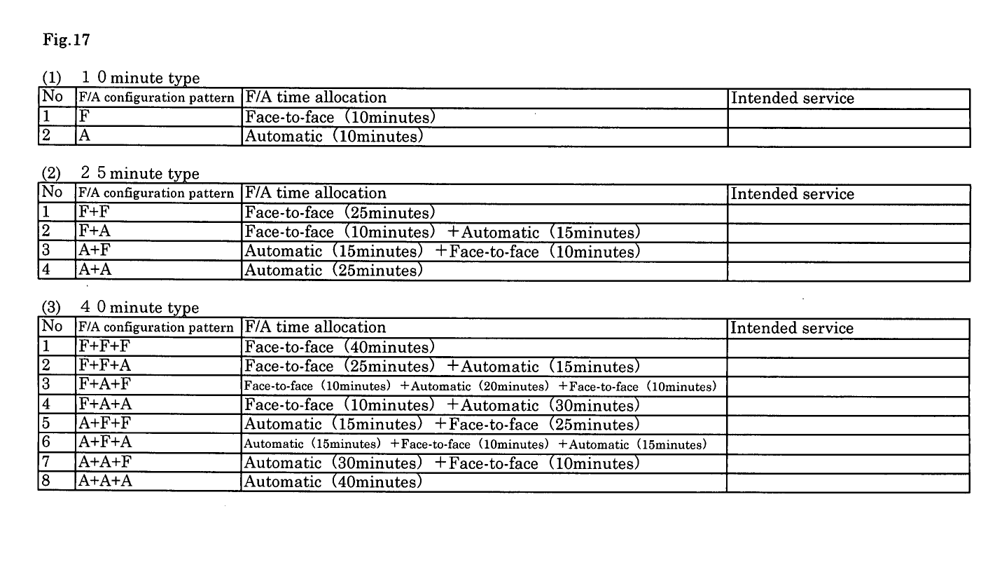

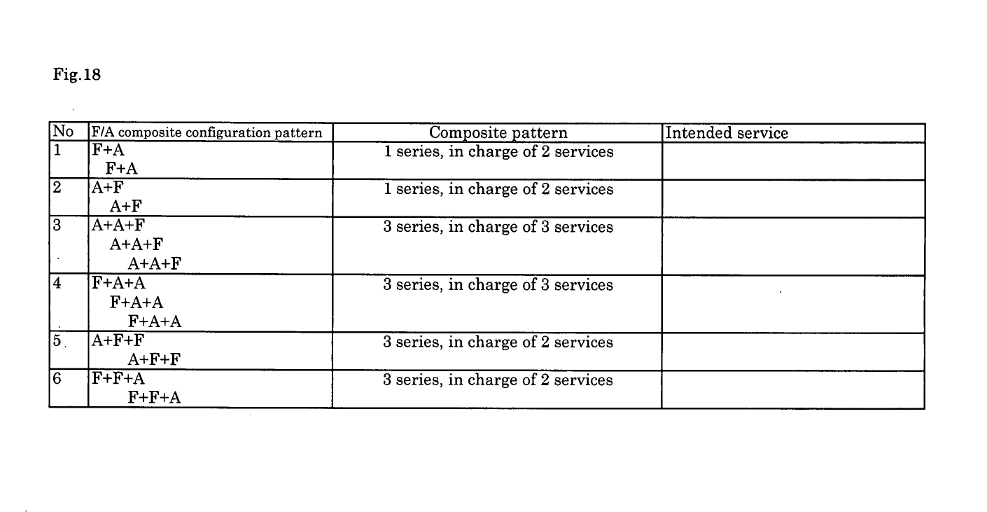

Then, this information communication service system is configured to provide services based on service menus which offer face-to-face services and automatic services in combination, with a basic unit of service of 15 minutes and a preparation time of 5 minutes for a chairperson or others. FIG. 17 shows examples of service configuration patterns for a 10-minute type, a 25-minute type, and a 40-minute type. In the diagram, F represents a face-to-face service, and A an automatic service. Since service menu files includes combinations of face-to-face and automatic services, a chairperson controls a plurality of services as shown in FIG. 18. This permits each single chairperson to control a number of services in parallel, which reduces personnel cost. It is therefore possible to provide interactive services for small groups at lower cost.

The system of the present invention can also provide the following services.

3. Group Debate Service

A plurality of attendants can hold mutual conversations via the bidirectional communication server 10 without a chairperson, with content delivery service by the content delivery server 12, if necessary.

4. Free Talk Service

A freely-accessible conference room is opened full-time, such that attendants can access this conference to have conversations with the chairperson and other attendants via the bidirectional communication server 10, with content delivery service by the content delivery server 12, if necessary.

In this manner, the members receive various modes of services in arbitrary combinations while staying at home.

### Function of Administration System

Now, description will be given of the functions and procedure of the administration system.

The administration system is in charge of service provision. To improve the efficiency of administration, maintain service quality, and enhance the mechanism for accepting members to be served, the administration system includes the membership information management system 50, the service assist system 52, the service executive control system 54, and the delivery service management system 56.

1. Membership Information Management System

The membership information management system 50 manages member information.

(1) Member Registration Function

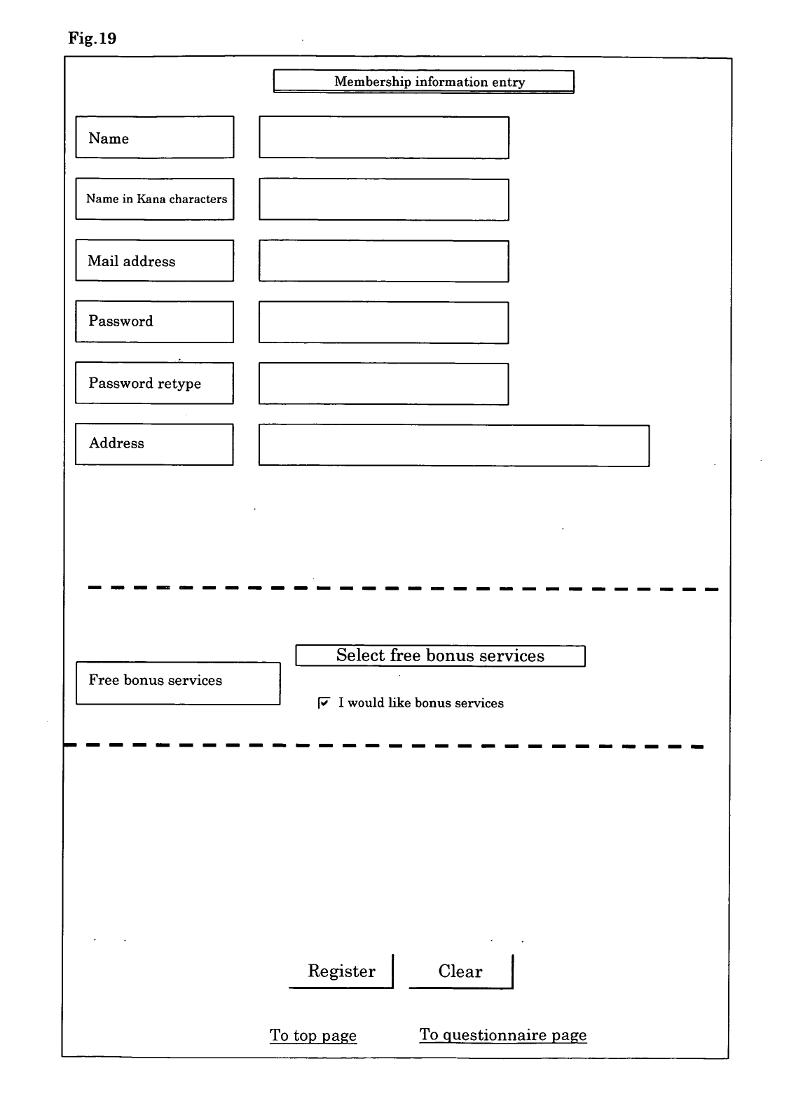

The member registration function accepts registration of membership information from a “Membership information registration” page on a Web site on the WWW server 16. FIG. 19 shows an example of a membership information entry screen. When the membership information management system 50 accepts registration, it issues an ID and a password, and sends a confirmation mail describing the issued ID, password, and the entered membership information to the member who entered the information. When the membership information management system 50 receives from the member a reply mail that indicates that no errors were present in the confirmation mail, it actually registers the ID, password, and entered information to its membership information database. In this manner, the registration information is confirmed by the mails to prevent erroneous member registration and to improve security.

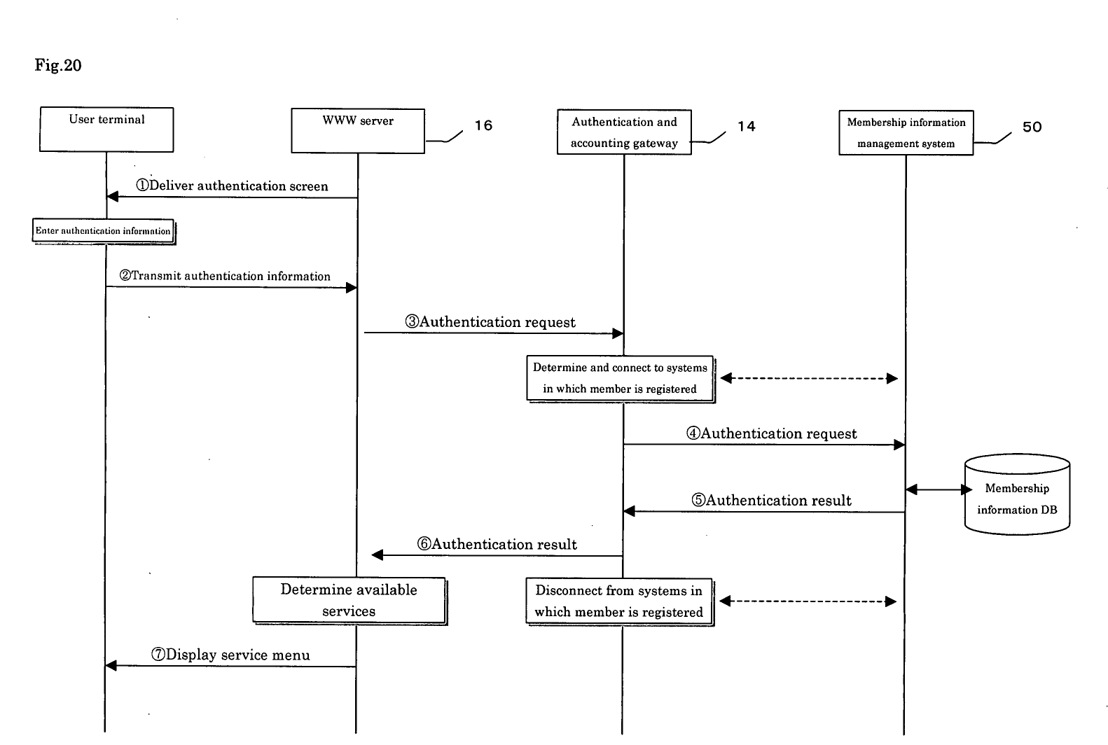

After registration, the ID and password are used to receive necessary member services on the Web site. FIG. 20 shows the procedure for performing member authentication and accounting by using the ID and password obtained through the member registration. When the member accesses a member services page provided on the WWW server 16 from his/her user terminal, an authentication screen is delivered. Here, the ID and password are entered, and the membership information management system 50 checks the authentication information via the authentication and accounting gateway 14. The membership information management system 50 consults the membership information database and posts the result of authentication to the WWW server 16. From the result of authentication, the WWW server 16 determines which services are available, and delivers the corresponding service menu to the user terminal.

While members are served through the authentication and accounting gateway 14, accounting for the members is performed. This information communication service system has the following three modes of accounting in view of the particularities of the services to be provided.

A first mode is to charge based on the connect times of user terminals. This mode measures the elapsed time from the confirmation of authentication by the authentication and accounting gateway 14 to disconnection at the completion of service. Consequently, charges are calculated separately even if the connect times vary user by user.

A second mode is to charge based on the connect time of the chairperson terminal used by a chairperson (such as an instructor, doctor, and consultant). This mode measures the time for which user terminals are checked in with the chairperson terminal 30 and the bidirectional communication server 10, and posts the time to the authentication and accounting gateway 14 after the completion of service. This provides charging based on the actual service time of the instructor, doctor, consultant, etc.

A third mode is to charge based on the content delivered. This mode obtains the charge information based on the content delivered from the content management server 20 when the content delivery server 12 delivers the content to user terminals, and posts the charge information to the authentication and accounting gateway 14 after the completion of service. This provides charging according to the content delivered.

As described above, this information communication service system includes the three modes of accounting and can combine these charging modes depending on the services. It is therefore possible to set appropriate charges in accordance with the services to be provided.

(2) Registration Information Inquiry and Modification Function

The registration information inquiry and modification function makes inquiries and modifications of the membership information registered. Again, when the membership information is modified, a confirmation mail describing the entered information is sent to the member. Actual registration is conducted after the reception of a reply mail that there are no errors in the confirmation mail.

Incidentally, this function permits the members to change their passwords as needed, thereby providing protection against unauthorized access by others.

(3) Questionnaire Management Function

The questionnaire management function accepts entries to questionnaires on a “Questionnaire” page of the Web site on the WWW server 16. The membership information management system 50 receives the entries to the questionnaires, and registers the entered information to its questionnaire database.

(4) Service Point Management Function

The service point management function manages points for member services. This information communication service system performs accounting of deposit type in order to avoid troublesome service-by-service money reception. Service points can be refilled only by the bureau which has a certain ID and password. When the reception of money from a member is confirmed, service points corresponding to the amount of money are added. For withdrawals, service points corresponding to the services to be provided are withdrawn automatically upon receiving notices from the service assist system at the time of service reservations. Incidentally, when services are cancelled, certain points are returned for notices from the service assist system according to predetermined conditions.

The members can check their current services points anytime by using the membership information inquiry function. When the service points fall to or below certain levels, the members are informed of it automatically by mail. As a result, the members can confirm their remaining service points anytime to avoid such troubles as unavailable services due to underpayment.

Incidentally, in the foregoing preferred embodiment, the service points are added when the reception of money is confirmed by the bureau. Alternatively, members may request to refill service points on the Web site or by mail such that the amounts of money corresponding to the points may be withdrawn from the members' bank accounts based on the requests. In this case, the points are added upon confirmation of the withdrawal.

(5) Bonus Score Management Function

The bonus score management function manages scores acquired by members who seek free bonus services (referred to as “bonus scores”). The membership information management system 50 grants additional bonus scores in any of the following cases:

(i) On Purchase of Service Points

The additional scores may be proportional to the purchased points, or increased stepwise.

(ii) After a Lapse of Predetermined Dates Since Member Registration

The additional scores may be proportional to the elapsed dates, or increased stepwise.

(iii) At a Predetermined Number of Times of Course Participation

The additional scores may be proportional to the number of times of participation, or increased stepwise.

(iv) For Questionnaire Answers

(v) In Promotion Periods

Certain additional scores may be granted for every member. Some scores may be added when predetermined conditions are met within a period. For example, additional bonus scores may be given to such members as those who consume a specific amount of services, who are recommended by chairpersons, who achieve improvements beyond a certain level in test evaluations, and who are newly registered.

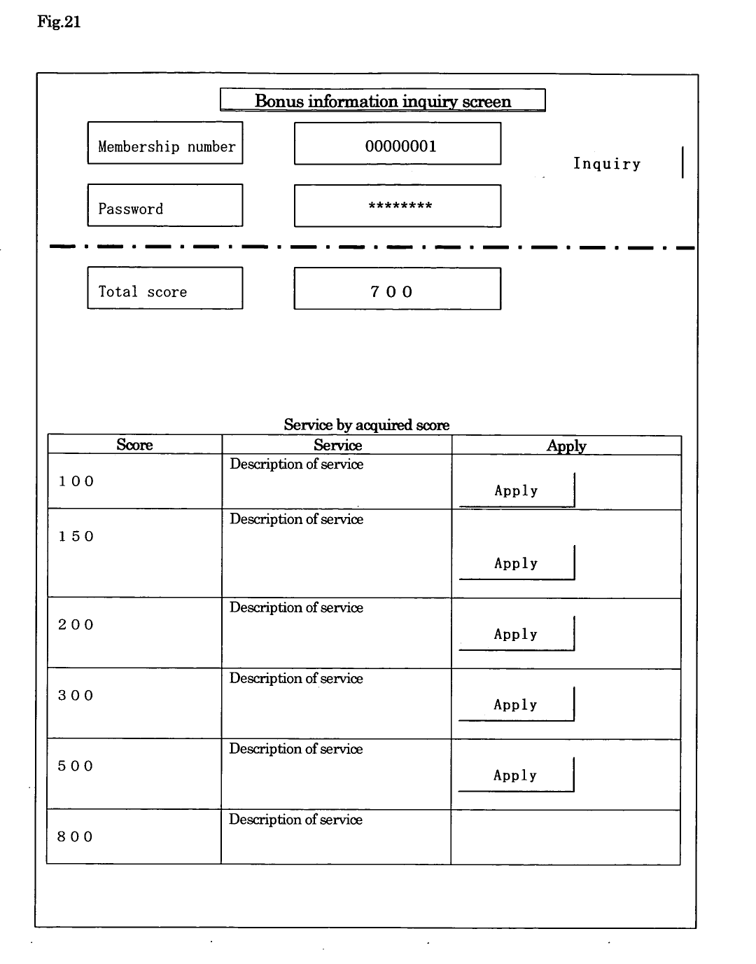

The bonus scores are registered in the membership information database. The details of the registration can be checked anytime on “Bonus information inquiry” page of the Web site on the WWW server 16. FIG. 21 shows an example of the bonus information inquiry screen. As shown in the diagram, the total score acquired thus far and the description of services available with the score are displayed. Applications for the services are made online. Free bonuses available to members include free courses, free access to the free-talk service, free tests, free delivery of content, travel discount tickets, and free gifts.

Mail describing free bonuses available to members may be sent automatically when predetermined bonus scores are achieved. The mail may contain the URL for accessing the foregoing Web site. Applications for the free bonuses may be accepted automatically by reply mail. In particular, it is highly effective to deliver mail referring to th occurrence of bonus points actively and automatically in promotion periods. As described above, incentives may be given for enrollment promotion, skill improvement, and other situations by providing members with the free bonus scoring system and actively informing them of how many bonus scores are accumulated and that free bonuses are available.

2. Service Assist System

The service assist system 52 is intended for efficient service provision.

(1) Course Registration Function

The course registration function accepts registration for courses for members to take, from “Course registration” page of the Web site on the WWW server 16. The accepted courses are coded and registered into a course registration database.

(2) Service Reservation Function

In response to service applications from members, the service reservation function provides the members with conference availability of the bidirectional communication server 10, availability of chairperson terminals 30, and availability of content delivery by the content delivery server 12. These availabilities are determined by consulting resource management files for managing the conference schedule of the bidirectional communication server 10, the use schedules of the chairperson terminals 30, the delivery schedule, and other schedule of the content delivery server 12. When the members reply for the services, the services are registered to service reservation transactions. Chairperson management files and the resource management files associated with the services are also updated. In this manner, the chairperson schedules and the resource availabilities are determined automatically for efficient reservation management.

The applications for services may be made in any of dial-up mode, Web mode, and interactive mode. In dial-up mode, the members call the bureau and input numbers for application according to voice guidance. In Web mode, applications are made from “Service reservation” page of the Web site on the WWW server 16. In interactive mode, applications are made by using the bidirectional communication server 10.

Incidentally, service reservations made previously can also be cancelled by modifying the service reservation transactions, the chairperson management files, and the resource management files based on the received details.

The foregoing preferred embodiment describes a case where services are assigned to member applications automatically with reference to the resource management files. However, the present invention is not limited thereto. An annual service schedule may be established in advance to accept member applications to this schedule such that service reservation transactions are issued based on the results of reception.

The foregoing preferred embodiment describes a case where services require advance reservations. However, the present invention is not limited thereto. Whether services are available or not may be determined with reference to the resource management file upon member applications, whereby the services are set when available. This makes it possible for the members to be served without reservation.

(3) Karte Management Function

The karte management function issues kartes for members who are registered in service courses, and keeps service histories.

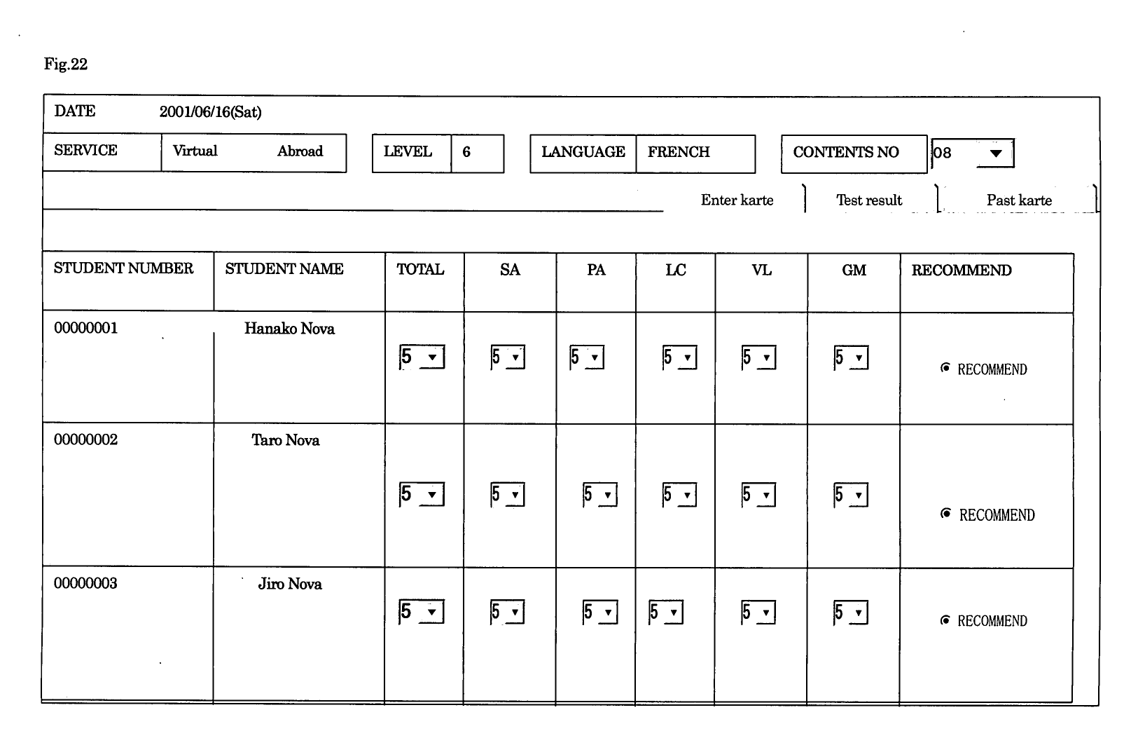

Each karte includes such items as the name, date, and evaluation of a service provided. In face-to-face services, evaluations are input service by service by the instructor, doctor, consultant, or others in charge. FIG. 22 shows an example of a karte entry screen.

In automatic services, quiz content is delivered at the end of the services, and the attendants answer to the same by button operations. The service assist system 52 rates the answers with reference to service evaluation automatic rating files, which describe the correspondence between answers and evaluations, and inputs the rated results into the records automatically. Evaluations is thus made even in automatic services, allowing detailed guidance for members.

3. Service Execution Control System

The service executive control system 54 is intended to manage the execution of services set by the service assist system 52.

(1) Service Executive Control Function

With reference to service reservation transactions, the service executive control function requests the bidirectional communication server 10 to set a conference room, and posts the addresses of attendant terminals and chairperson terminal to connect a predetermined time before a service reservation. The bidirectional communication server 10 thus sets a conference room, and accepts connection requests from the attendant terminals and chairperson terminal 30 notified.

At service start time, the service executive control system 54 posts the addresses of the destination attendant terminals and chairperson terminal to the content delivery server 12, thereby preparing for delivery. Consequently, with interactive services, the content delivery server 12 informs the chairperson terminal that the preparation for delivery is completed, and starts delivery under a delivery start instruction from the chairperson terminal. In automatic services, the content delivery server 12 informs the attendant terminals that the preparation for delivery is completed, and starts delivery under delivery start instructions from the attendant terminals.

4. Delivery Service Management System

The delivery service management system 56 provides centralized control over mail delivery for registered members.

The mail delivery covers confirmation mail concerning the registration and modification of membership information, notification of bonus scores, and delivery of member-requested content. Moreover, direct mail concerning various events, promotion information, and other events are also delivered.

In the foregoing preferred embodiment, the Internet is used as the communication lines. The services are thus available to even remote locations anytime without incurring telephone bills. The foregoing preferred embodiment describes a case where the chairperson uses a chairperson terminal 30 in the information communication service center. Nevertheless, the present invention is not limited thereto, and the chairperson may use a user terminal connected to the Internet. This is provided by setting a chairpersonship flag for a certain user terminal as described above. Consequently, as long as an Internet-accessible user terminal is available, the chairperson provides services from anywhere at any time. This provides more flexible service.

The foregoing preferred embodiment describes a case where the Internet is used as the communication lines. However, the present invention is not limited thereto. Telephone lines may be used to connect to the information communication service center directly.

Alternatively, LAN, WAN, and other networks may be used in such applications as corporate education and school education. The present invention also provides the same services even when used for services to be provided in a certain group. Needless to say, the communication lines are not limited to wired ones, but may also be wireless ones.

The present invention is also applicable to situations where the information communication service center includes booths for providing service. Combinations of interactive services and automatic services are thus provided to offer services using a variety of multimedia content while allowing service providers to control a plurality of services, which reduces personnel cost.

The foregoing preferred embodiment describes case where the user terminals used by the members are personal computers having an interface function for a TV camera and a microphone, and an Internet connection function. Nevertheless, any kind of terminal can be used as long as it is connectable to the communication lines an includes the interface function for a TV camera and a microphone. Available terminals include PDAs, game consoles, and other mobile terminals in addition to dedicated terminals. Such devices as a cellular phone with a TV camera are also expected to be available in the future, and full use of such devices will widen the range of target users.

As has been described, according to the present invention, the multimedia information communication service system includes the bidirectional communication device for conducting bidirectional communication using multimedia information, the content management device for storing multimedia content, and the content delivery device for delivering the content stored in the content management device to user terminals. The multimedia information communication service system thus provides a the bidirectional interactive function using multimedia information including TV pictures and sounds, and delivers multimedia content such as moving images, still images, and text. This permits the user terminals to conduct conversations while receiving delivery of the multimedia content simultaneously, with the effect that sophisticated information communication services are available.

The present invention is not limited to each of the above-described preferred embodiments, and various modifications are possible within the range described in the claims. An embodiment obtained by appropriately combining technical features disclosed in each of the different preferred embodiments is included in the technical scope of the present invention.

1: A multimedia information communication service system for providing an interactive information communication service using multimedia information between a plurality of user terminals connected to a network, comprising:
a bidirectional communication server for providing, between the user terminals, bidirectional communication using multimedia information including TV pictures and sounds;
a content management server for storing contents to be delivered to the user terminals; and
a content delivery server for delivering the contents stored in the contents management system to the user terminals.

2: The multimedia information communication service system according to claim 1, wherein the contents management server includes a material content storing device for storing material content, and a scenario storing device for storing a scenario defining a combination of the material contents along a time axis, and the content delivery server retrieves and delivers the material content stored in the material contents storing device based on the scenario stored in the scenario storing device.

3: The multimedia information communication service system according to claim 1, wherein the bidirectional communication server synthesizes the multimedia information transmitted from the plurality of user terminals and delivering a resultant of the multimedia information to the user terminals.

4: The multimedia information communication service system according to claim 1, wherein the bidirectional communication server delivers the multimedia information transmitted from the plurality of user terminals to user terminals other than a source of the multimedia information thereof separately.

5: The multimedia information communication service system according to claim 1, wherein the bidirectional communication server enables a certain user terminal to control a configuration of screens to be displayed on the user terminals.

6: The multimedia information communication service system according to claim 1, wherein the bidirectional communication server enables a certain user terminal to control the allocation of sounds of the respective users to be output on the user terminals.

7: The multimedia information communication service system according to claim 1, wherein the bidirectional communication server controls the configuration of screens to be displayed on the user terminals based on a magnitude of sound data transmitted from the user terminals.

8: The multimedia information communication service system according to claim 1, wherein the bidirectional communication server includes a data conference function for sharing an application to be performed on the user terminals.

9: The multimedia information communication service system according to claim 1, wherein the bidirectional communication server includes a chat function for providing bidirectional communications between the user terminals by text entry.

10: The multimedia information communication service system according to claim 1, wherein the bidirectional communication server modifies a quality of information to be transmitted in accordance with a communication band of the network.

11: The multimedia information communication service system according to claim 1, wherein the contents delivery server controls content replay from the user terminals.

12: The multimedia information communication service system according to claim 1, wherein the contents delivery server includes a picture and sound link device which links live pictures and sounds.

13: The multimedia information communication service system according to claim 1, wherein the content delivery server modifies a quality of information to be transmitted in accordance with a communication band of the network.

14: The multimedia information communication service system according to claim 1, further comprising a resource management device for managing availability of the bidirectional communication device and connections of the user terminals.

15: The multimedia information communication service system according to claim 1, further comprising an accounting device for calculating service charges for users, the accounting device summarizes connect times of the user terminals used by the users and conducts charging.

16: The multimedia information communication service system according to claim 1, further comprising an accounting device for calculating service charges for users, the accounting device summarizes a connect time of a user terminal used by a predetermined one other than the users and conducts charging.

17: The multimedia information communication service system according to claim 1, further comprising an accounting device for calculating service charges for users, the accounting device acquires predetermined charge information of content to be provided by the content delivery device and conducts charging.

18: The multimedia information communication service system according to claim 1, wherein some or all of the user terminals are connected over the Internet.

19: A program for use on a user terminal of the multimedia information communication service system according to claim 1, comprising:
means for acquiring a TV picture and sound of the user terminal;
means for transmitting the TV picture and sound acquired;
means for receiving TV pictures and sounds from the bidirectional communication server;
means for receiving multimedia contents from the content delivery server; and
means for creating a predetermined window to output the received TV pictures and sounds and the received multimedia content.

20: A computer-readable recording medium recording the program according to claim 19 for use on a user terminal of the multimedia information communication service system.
